(19) United States
(12) Patent Application Publication
(10) Pub. No.: US 2026/0004524 A1
(43) Pub. Date: Jan. 1, 2026

(54) 3D REPRESENTATION MERGING FOR CONTENT ENHANCEMENTS

(71) Applicant: Apple Inc., Cupertino, CA (US)

(72) Inventors: Gowri Somanath, San Jose, CA (US); Tobias Holl, Sunnyvale, CA (US); Waleed Abdulla, Mountain View, CA (US)

(21) Appl. No.: 19/254,502

(22) Filed: Jun. 30, 2025

Related U.S. Application Data
(60) Provisional application No. 63/666,415, filed on Jul. 1, 2024.

(51) Int. Cl. G06T 17/20; G06V 10/25; G06V 10/26; G06V 10/60

(52) U.S. Cl. CPC G06T 17/20; G06V 10/25; G06V 10/26; G06V 10/60; G06V 2201/07

(57) ABSTRACT

Various implementations disclosed herein include devices, systems, and methods for providing a view of a three-dimensional (3D) representation that is generated by merging 3D representations based on identified regions of interest and location. For example, a process may include obtaining a first 3D representation of a physical environment and a second 3D representation that was generated based on frames of image data of an area of the physical environment. The process may further include identifying a region of interest associated with the second 3D representation and identifying a portion of the first 3D representation based on the first area depicted in the image data and the identified region of interest. The process may further include generating a merged 3D representation by combining the identified portion of the first 3D representation with a portion of the second 3D representation, and presenting a view of the merged 3D representation.

### CROSS-REFERENCE TO RELATED APPLICATIONS

This application claims the benefit of U.S. Provisional Application Ser. No. 63/666,415 filed Jul. 1, 2024, which is incorporated herein in its entirety.

### TECHNICAL FIELD

The present disclosure generally relates to systems, methods, and electronic devices for providing a view of a three-dimensional (3D) representation that is generated by merging different 3D representations based on identified regions of interest.

### BACKGROUND

Existing systems and techniques may be improved with respect to viewing recorded content (e.g., images and/or video).

### SUMMARY

Various implementations disclosed herein include devices, systems, and methods that display an immersive memory by identifying regions of interest of a recorded image or video and merging the identified regions of interest form the recording with an obtained persistent model (e.g., an immersive view, such as a larger field-of-view for a three-dimensional (3D) environment). For example, a view of the immersive memory (e.g., a 3D environment) may be displayed on a first device (e.g., a head mounted device (HMD)) based on merging a previously generated 3D representation of a physical environment (e.g., a 3D persistent ‘reusable’ model of a home) with a 3D representation of a captured video (e.g., a memory) for a particular area (e.g., a living room) captured by a second device (e.g., a mobile phone or tablet with a smaller FOV of the captured image/video).

In various implementations, the merged 3D representation may extrapolate the identified key objects of interest (e.g., people, foreground objects, etc.) and expand the limited view from the image/video to a 180° or greater (e.g., 360°) view for the viewing device, e.g., an HMD. In some implementations, the 3D representation of the scene may be tracked and/or developed over time. For example, as a user scans his or environment with the viewing device or the mobile device, the persistent model of the home may be updated in order to provide up-to-date information of the environment for the merged representation.

In various implementations, the subjects of interest may be identified and represented in the captured 3D representation (e.g., the 3D representation of the image/video) based on one or more different criterion. The identification of the subjects of interest may be based on salient region detection, which aims to localize and identify precise detection and segmentation of visually distinctive image regions or subjects/objects from the perspective of the human visual system. For example, the subjects of interest may only be people (and/or pets) in the image/video. If there are several people (e.g., a video of a party), then various implementations may only use representations of people who are in the foreground or are the main focus of a majority of the frames of the video. If a person or object is mostly cutoff from the image/video, then that person may be excluded from the captured 3D representation and not identified as a subject of interest (e.g., assuming the person who captured the image/video did not intend for that person to be a subject of interest since that person was cut off from the image/video). Additionally, if a person is holding/modifying/using an object (e.g., a child playing with a toy, a user holding a phone, etc.), then that object may also be identified as a subject of interest to be included in the captured 3D representation.

In various implementations, regions of interest (or subjects/objects of interest) may not have to be identified from a recording, but instead, the system may merge an entire recorded video with a persistent model. For example, the system may place the recording in its location of the persistent model with the correct scale such that the persistent model does not replace any part of the recorded video but expands on what is displayed outside of the capturing device's field of view (FOV) using the persistent model. In some implementations, the system may provide some visual treatments, such as, inter alia, adjustments and/or augmentations on the parts of the recorded video that is included from the persistent model (e.g., some degree of blurring and the like) and vice versa. Thus, as discussed herein, a “region” of an image may include or may refer to an object, a subject, or a general area of an image (e.g., may be an entire image FOV merged with a persistent model).

In various implementations, merging details from the scene representation and the captured 3D representation may be combined (e.g., correcting gaps, match lighting from the video/image, etc.). Moreover, the merged 3D representation provides the benefit of generating an expanded view for the viewer (e.g., the enhanced view is wider than the original captured image/video). For example, the image/video may be captured on a mobile device for a small area (e.g., children playing on a floor in a corner or small area of a room and you can only see a small portion of the room), but the merged 3D representation allows a viewer (e.g., wearing an HMD) to look around and view the entire room as an immersive memory. In other words, the 3D representations of the children will be playing in the living room, but the viewer can simultaneously turn his or her head or move his or her viewing point in the 3D environment and view the entire living room (e.g., such as a view within an extended reality (XR) environment) even though the entire living room was not captured in the captured image/video.

In general, one innovative aspect of the subject matter described in this specification can be embodied in methods, at a first electronic device having a processor, that include the actions of obtaining a first three-dimensional (3D) representation of a physical environment, wherein the physical environment comprises one or more areas. The actions further include obtaining a second 3D representation that was generated by identifying one or more objects of interest based on one or more frames of image data, where the image data depicts a first area of the one or more areas of the physical environment. The actions further include identifying a portion of the first 3D representation based on the first area depicted in the image data and the identified one or more regions of interest. The actions further include generating a merged 3D representation by combining the identified portion of the first 3D representation with at least a portion of the second 3D representation. The actions further include presenting a view of the merged 3D representation.

These and other embodiments may each optionally include one or more of the following features.

In some aspects, the second 3D representation was further generated by identifying one or more scene properties based on the one or more frames of image data. In some aspects, identifying the one or more scene properties comprises identifying one or more lighting properties associated with a lighting condition of the first area of the physical environment. In some aspects, identifying the one or more scene properties comprises identifying occlusions corresponding to the one or more regions of interest. In some aspects, the actions may further include updating the merged 3D representation based on the identified one or more scene properties. In some aspects, updating the merged 3D representation based on the identified one or more scene properties comprises hallucinating content for the view of the merged 3D representation.

In some aspects, identifying the one or more regions of interest based on the one or more frames of image data comprises extracting data from the image data corresponding to one or more persons. In some aspects, identifying the one or more regions of interest based on the one or more frames of image data comprises extracting data from the image data corresponding to one or more persons and extracting data from the image data corresponding to objects associated with the one or more persons

In some aspects, the second 3D representation comprises a plurality of persons, wherein identifying the one or more regions of interest based on the one or more frames of image data comprises extracting data from the image data corresponding to at least one person of the plurality of persons based on prioritization parameters.

In some aspects, identifying the one or more regions of interest based on the one or more frames of image data comprises determining that the second 3D representation is missing at least a portion of an identified first region of interest. In some aspects, generating the merged 3D representation comprises generating additional content associated with the at least the portion of the identified first region of interest. In some aspects, generating the merged 3D representation comprises excluding data from the second 3D representation corresponding to the identified first region of interest.

In some aspects, identifying the portion of the first 3D representation based on the first area depicted in the image data and the identified one or more regions of interest is based on location data, object recognition data, or a combination thereof. In some aspects, the view of the merged 3D representation is displayed on a larger field-of-view than a field-of-view associated with the image data.

In some aspects, the first 3D representation comprises a temporal-based attribute that corresponds to a version of the first 3D representation. In some aspects, the actions may further include determining, based on the temporal-based attribute, that there is an updated version of the first 3D representation, obtaining the updated version of the first 3D representation, and updating the merged 3D representation based on the updated version of the first 3D representation.

In some aspects, the first 3D representation was generated by the first electronic device. In some aspects, the first 3D representation or the second 3D representation was obtained from a second electronic device.

In some aspects, the view of the merged 3D representation is presented in an extended reality (XR) environment. In some aspects, the first electronic device comprises a head-mounted device (HMD).

In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIGS. 1A-1B illustrate exemplary electronic devices operating in a physical environment, in accordance with some implementations.

FIG. 2 illustrates a portion of a three-dimensional (3D) point cloud representing the room of FIGS. 1A-1B, in accordance with some implementations.

FIG. 3 illustrates a portion of a 3D floor plan representing the room of FIGS. 1A-1B, in accordance with some implementations.

FIG. 4 is a view of the 3D floor plan of FIG. 3.

FIG. 5 is another view of the 3D floor plan of FIGS. 3 and 4.

FIG. 6 is a system flow diagram of an example generation of 3D representations of one or more objects based on salient region data and scene data, in accordance with some implementations.

FIG. 7 illustrates an exemplary environment to generate and display enhanced memory content by merging an environment representation and a memory representation, in accordance with some implementations.

FIG. 8A illustrates an exemplary electronic device operating in a different physical environment than the physical environment of FIGS. 1A-1B, in accordance with some implementations.

FIGS. 8B-8D illustrate exemplary views of an extended reality (XR) environment provided by the device of FIG. 8A, in accordance with some implementations.

FIG. 9 is a flowchart illustrating a method for presenting a view of a merged 3D representation in accordance with some implementations.

FIG. 10 is a block diagram of an electronic device of in accordance with some implementations.

FIG. 11 is a block diagram of an exemplary head-mounted device in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

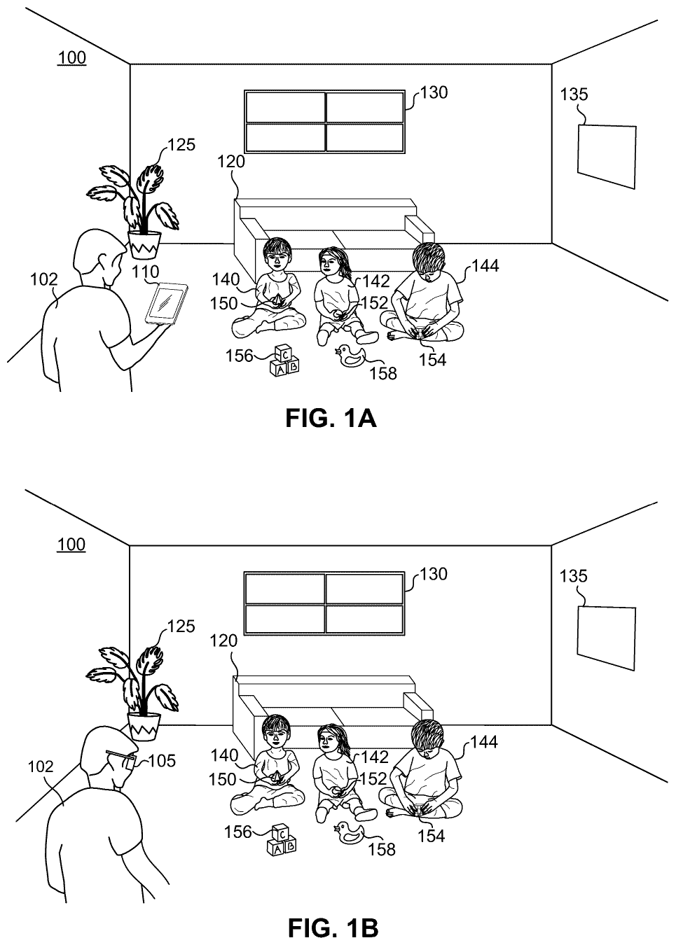

FIGS. 1A-1B illustrate exemplary electronic devices 105 and 110 operating in a physical environment 100. In the example of FIGS. 1A-1B, the physical environment 100 is a room that includes a couch 120, a plant 125, a window 130, and a screen 135. Additionally, the physical environment 100 includes child 140, child 142, and child 144, playing with toys 150, 152, 154, 156, and 158. The electronic devices 105 and 110 may include one or more cameras, microphones, depth sensors, or other sensors that can be used to capture information about and evaluate the physical environment 100 and the objects within it (e.g., recording a video of the children playing with the toys), as well as information about the user 102 of electronic devices 105 and 110. The information about the physical environment 100 and/or user 102 may be used to provide visual and audio content and/or to identify the current location of the physical environment 100 and/or the location of the user within the physical environment 100.

In some implementations, views of an extended reality (XR) environment may be provided to one or more participants (e.g., user 102 and/or other participants not shown) via electronic devices 105 (e.g., a wearable device such as an HMD) and/or 110 (e.g., a handheld device such as a mobile device, a tablet computing device, a laptop computer, etc.). Such an XR environment may include views of a 3D environment that is generated based on camera images and/or depth camera images of the physical environment 100 as well as a representation of user 102 based on camera images and/or depth camera images of the user 102. Such an XR environment may include virtual content that is positioned at 3D locations relative to a 3D coordinate system (e.g., a 3D space) associated with the XR environment, which may correspond to a 3D coordinate system of the physical environment 100.

In some implementations, video (e.g., pass-through video depicting a physical environment) is received from an image sensor of a device (e.g., device 105 or device 110) and used to present the XR environment. In other implementations, optical see-through may be used to present the XR environment by overlaying virtual content on a view of the physical environment seen through a translucent or transparent display. In some implementations, a 3D representation of a virtual environment is aligned with a 3D coordinate system of the physical environment. A sizing of the 3D representation of the virtual environment may be generated based on, inter alia, a scale of the physical environment or a positioning of an open space, floor, wall, etc. such that the 3D representation is configured to align with corresponding features of the physical environment. In some implementations, a viewpoint within the 3D coordinate system may be determined based on a position of the electronic device within the physical environment. The viewpoint may be determined based on, inter alia, image data, depth sensor data, motion sensor data, etc., which may be retrieved via a virtual inertial odometry system (VIO), a simultaneous localization and mapping (SLAM) system, etc.

People may sense or interact with a physical environment or world without using an electronic device. Physical features, such as a physical object or surface, may be included within a physical environment. For instance, a physical environment may correspond to a physical city having physical buildings, roads, and vehicles. People may directly sense or interact with a physical environment through various means, such as smell, sight, taste, hearing, and touch. This can be in contrast to an extended reality (XR) environment that may refer to a partially or wholly simulated environment that people may sense or interact with using an electronic device. The XR environment may include virtual reality (VR) content, mixed reality (MR) content, augmented reality (AR) content, or the like. Using an XR system, a portion of a person's physical motions, or representations thereof, may be tracked and, in response, properties of virtual objects in the XR environment may be changed in a way that complies with at least one law of nature. For example, the XR system may detect a user's head movement and adjust auditory and graphical content presented to the user in a way that simulates how sounds and views would change in a physical environment. In other examples, the XR system may detect movement of an electronic device (e.g., a laptop, tablet, mobile phone, or the like) presenting the XR environment. Accordingly, the XR system may adjust auditory and graphical content presented to the user in a way that simulates how sounds and views would change in a physical environment. In some instances, other inputs, such as a representation of physical motion (e.g., a voice command), may cause the XR system to adjust properties of graphical content.

Numerous types of electronic systems may allow a user to sense or interact with an XR environment. A non-exhaustive list of examples includes lenses having integrated display capability to be placed on a user's eyes (e.g., contact lenses), heads-up displays (HUDs), projection-based systems, head mountable systems, windows or windshields having integrated display technology, headphones/earphones, input systems with or without haptic feedback (e.g., handheld or wearable controllers), smartphones, tablets, desktop/laptop computers, and speaker arrays. Head mountable systems may include an opaque display and one or more speakers. Other head mountable systems may be configured to receive an opaque external display, such as that of a smartphone. Head mountable systems may capture images/video of the physical environment using one or more image sensors or capture audio of the physical environment using one or more microphones. Instead of an opaque display, some head mountable systems may include a transparent or translucent display. Transparent or translucent displays may have direct light representative of images to a user's eyes through a medium, such as a hologram medium, optical waveguide, an optical combiner, optical reflector, other similar technologies, or combinations thereof. Various display technologies, such as liquid crystal on silicon, LEDs, uLEDs, OLEDs, laser scanning light source, digital light projection, or combinations thereof, may be used. In some examples, the transparent or translucent display may be selectively controlled to become opaque. Projection-based systems may utilize retinal projection technology that projects images onto a user's retina or may project virtual content into the physical environment, such as onto a physical surface or as a hologram.

While this example and other examples discussed herein illustrates a single device 110 in a real-world physical environment 100, the techniques disclosed herein are applicable to multiple devices and multiple sensors, as well as to other real-world environments/experiences. For example, the functions of the device 110 may be performed by multiple devices.

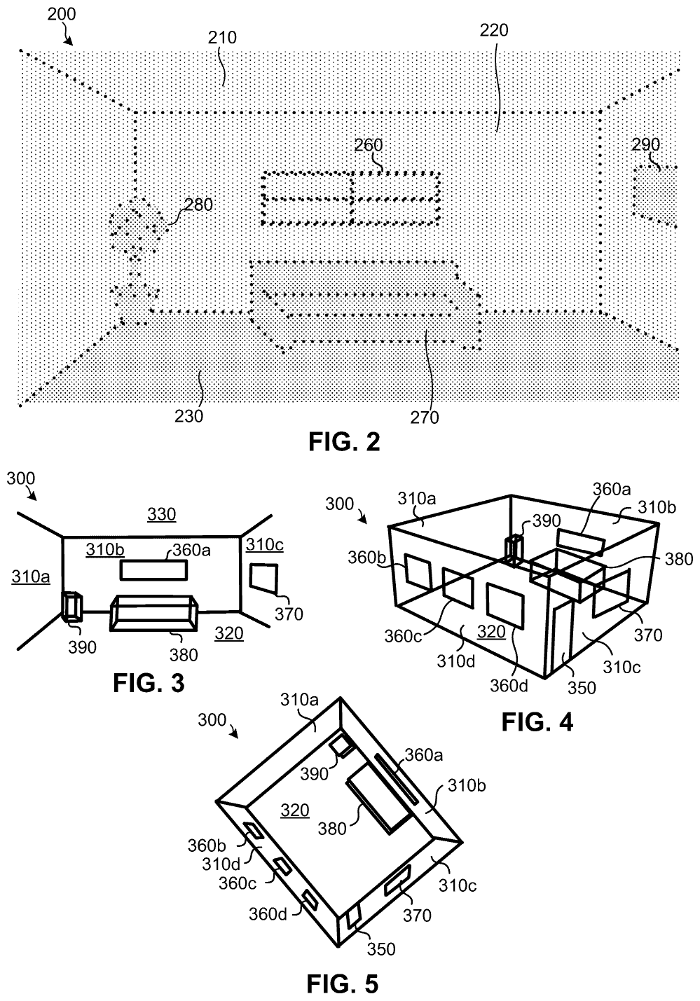

FIG. 2 illustrates a portion of a 3D point cloud representing the room of the physical environment 100 of FIGS. 1A-1B. In some implementations, the 3D point cloud 200 is generated based on one or more images (e.g., greyscale, RGB, etc.), one or more depth images, and motion data regarding movement of the device in between different image captures. In some implementations, an initial 3D point cloud is generated based on sensor data and then the initial 3D point cloud is densified via an algorithm, machine learning model, or other process that adds additional points to the 3D point cloud. The 3D point cloud 200 may include information identifying 3D coordinates of points in a 3D coordinate system. Each of the points may be associated with characteristic information, e.g., identifying a color of the point based on the color of the corresponding portion of an object or surface in the physical environment 100, a surface normal direction based on the surface normal direction of the corresponding portion of the object or surface in the physical environment 100, a semantic label identifying the type of object with which the point is associated, etc.

In alternative implementations, a 3D mesh is generated in which points of the 3D mesh have 3D coordinates such that groups of the mesh points identify surface portions, e.g., triangles, corresponding to surfaces of the room of the physical environment 100. Such points and/or associated mesh shapes (e.g., triangles) may be associated with color, surface normal directions, and/or semantic labels.

In the example of FIG. 2, the 3D point cloud 200 includes a set of points 210 representing a ceiling, a set of points 220 representing a wall (e.g., the back wall with the window 130), a set of points 230 representing the floor, a set of points 260 representing the window 130, a set of points 270 representing the couch 120, a set of points 280 representing the plant 125, and a set of points 290 representing the screen 135. In this example, the points of the 3D point cloud 200 are depicted with relative uniformity and with points on object edges emphasized to facilitate easier understanding of the figures. However, it should be understood that the 3D point cloud 200 need not include uniformly distributed points and need not include points representing object edges that are emphasized or otherwise different than other points of the 3D point cloud 200.

The 3D point cloud 200 may be used to identify one or more boundaries and/or regions (e.g., walls, floors, ceilings, etc.) within the room of the physical environment 100. The relative positions of these surfaces may be determined relative to the physical environment 100 and/or the 3D point-based representation 200. In some implementations, a plane detection algorithm, machine learning model, or other technique is performed using sensor data and/or a 3D point-based representation (such as 3D point cloud 200). The plane detection algorithm may detect the 3D positions in a 3D coordinate system of one or more planes of physical environment 100. The detected planes may be defined by one or more boundaries, corners, or other 3D spatial parameters. The detected planes may be associated with one or more types of features, e.g., wall, ceiling, floor, table-top, counter-top, cabinet front, etc., and/or may be semantically labelled. Detected planes associated with certain features (e.g., walls, floors, ceilings, etc.) may be analyzed with respect to whether such planes include windows, doors, and openings. Similarly, the 3D point cloud 200 may be used to identify one or more boundaries or bounding boxes around one or more objects, e.g., bounding boxes corresponding to couch 120 and plant 125.

The 3D point cloud 200 is used to generate room plan 300 (as illustrated in FIGS. 3-5) representing one or more rooms of the physical environment 100 of FIG. 1. For example, detected planes, boundaries, bounding boxes, etc. may be detected and used to generate shapes, e.g., 2D shapes and/or 3D primitives that parametrically represent the elements of the room of the physical environment 100. In FIGS. 3-5, wall representations 310a-d represent the walls of the room, floor representation 320 represents the floor of the room, door representation 350 represent a door of the room (e.g., a door not visible in the illustrated view from FIGS. 1 and 2), window representations 360a-d represent the windows of the room (e.g., window representation 360a represents window 130), television representation 370 represents a television screen 135 hanging on the wall, desk representation 380 is a bounding box representing couch 120, and representation 390 is a bounding box representing plant 125. A bounding box representation may have 3D dimensions that correspond to the dimensions of the object itself, providing a simplified yet scaled representation of the object. In this example, the 3D room plan 300 includes object representations for non-room-boundaries, e.g., for 3D objects within the room such as couch 120 and plant 125, and thus represents more than just the approximately planar, architectural floor plan elements. In other implementations, a 3D room plan is simply a 3D floor plan, representing only planar, architectural floor plan element, e.g., walls, floor, doors, windows, etc.

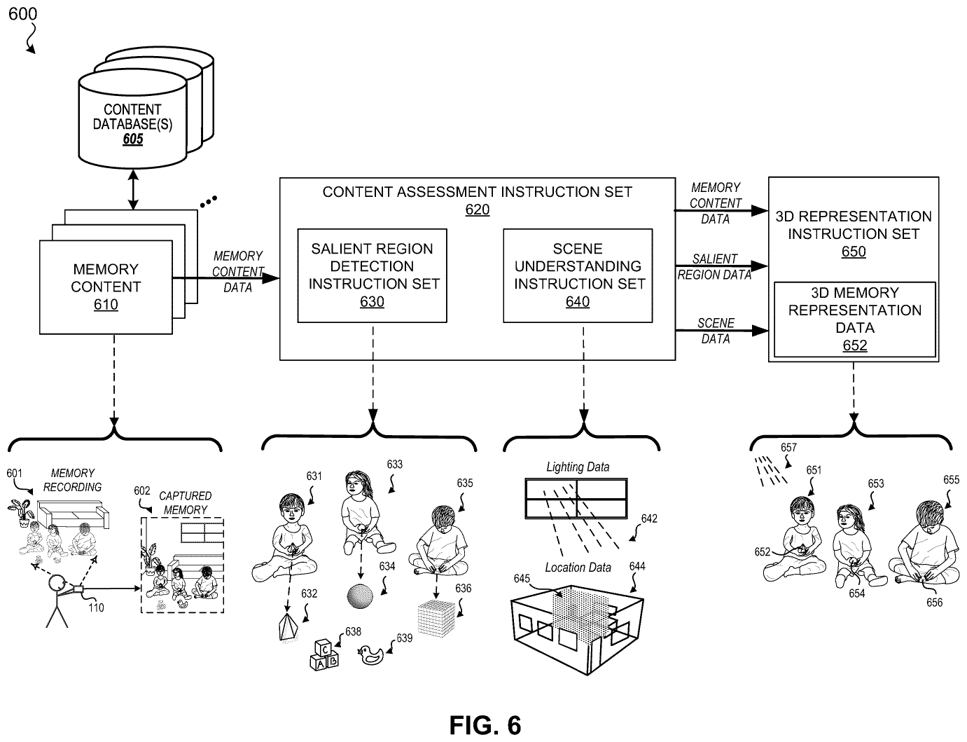

FIG. 6 is a system flow diagram of an example environment 600 in which a system can generate 3D representations of one or more objects based on salient region data and scene data, according to some implementations. In some implementations, the system flow of the example environment 600 is performed on a device (e.g., device 110 of FIG. 1A, device 105 of FIG. 1B, etc.), such as a mobile device, desktop, laptop, or server device. The images of the example environment 600 can be displayed on a device that has a screen for displaying images (e.g., device 110 of FIG. 1A) and/or a screen for viewing stereoscopic images such as a head-mounted device (HMD) (e.g., device 105 of FIG. 1B). In some implementations, the system flow of the example environment 600 is performed on processing logic, including hardware, firmware, software, or a combination thereof. In some implementations, the system flow of the example environment 600 is performed on a processor executing code stored in a non-transitory computer-readable medium (e.g., a memory).

The system flow of the example environment 600 acquires memory content 610 from one or more sources. In some implementations, memory content data may include images and/or video of captured memory content 602 of a memory recording 601. For example, the user 102 is recording a video of children playing with toys, and the captured memory content 602 (e.g., image(s) and/or video) is then stored as memory content 610. In some implementations, memory content 610 may include images and/or video previously stored in one or more content database(s) 605 stored locally on a device (e.g., device 110 of FIG. 1A, device 105 of FIG. 1B, etc.), such as a mobile device, desktop, laptop, or server device, or the one or more content database(s) 605 may be stored remotely on another device, such as a server (e.g., a cloud based server) that may be accessed by the local (viewing) device. The memory content data (e.g., captured memory 602) may be captured from sensors on the device that acquire light intensity image data (e.g., live camera feed such as RGB from a light intensity camera), depth image data (e.g., RGB-D from a depth camera), and other sources of physical environment information (e.g., camera positioning information such as position and orientation data from position sensors) of a physical environment (e.g., the physical environment 100 of FIGS. 1A-1B).

For the positioning information, some implementations include a visual inertial odometry (VIO) system to determine equivalent odometry information using sequential camera images (e.g., light intensity data) to estimate the distance traveled. Alternatively, some implementations of the present disclosure may include a SLAM system (e.g., position sensors). The SLAM system may include a multidimensional (e.g., 3D) laser scanning and range measuring system that is GPS-independent and that provides real-time simultaneous location and mapping. The SLAM system may generate and manage data for a very accurate point cloud that results from reflections of laser scanning from objects in an environment. Movements of any of the points in the point cloud are accurately tracked over time, so that the SLAM system can maintain precise understanding of its location and orientation as it travels through an environment, using the points in the point cloud as reference points for the location.

In an example implementation, the environment 600 includes an content assessment instruction set 620 that is configured with instructions executable by a processor to obtain memory content data (e.g., image data such as light intensity data, depth data, camera position information, etc.) and determine salient region data, scene data, and other data using one or more of the techniques disclosed herein, and provide the data to the 3D representation instruction set 650.

In some implementations, the content assessment instruction set 620 includes a salient region detection instruction set 630 that is configured with instructions executable by a processor to analyze the image information from the memory content 610 and identify objects within the image data, and determine which identified objects are salient regions (e.g., identify precise detection and segmentation of visually distinctive image regions or subjects/objects from the perspective of the human visual system.) For example, the salient region detection instruction set 630 of the content assessment instruction set 620 analyzes images/video content (e.g., memory content 610) to identify objects (e.g., people, toys, furniture, appliances, etc.) within each frame of the one or more frames of image content, and then the salient region detection instruction set 630 determines which of those objects are salient regions within each frame. For example, based on the captured memory 602 (e.g., a video of the children playing with toys), the salient region detection instruction set 630 identifies salient person 631 (e.g., child 140), salient person 633 (e.g., child 142), salient person 635 (e.g., child 144), salient region 632 (e.g., toy 150 held by child 140), salient region 634 (e.g., toy 152 held by child 142), salient region 636 (e.g., toy 154 held by child 144), salient region 638 (e.g., toy 156 on the floor), and salient region 639 (e.g., toy 158 on the floor). In some implementations, the salient region detection instruction set 630 may refine the identified salient regions based one or more criterion (e.g., distance thresholds, people only, objects but only if people are touching/using the object, etc.), thus the salient region 638 (e.g., toy 156 on the floor) and salient region 639 (e.g., toy 158 on the floor), may be excluded from the salient region identification list. In other words, the key portion “memory” detected was the children playing with toys, thus only the children (and the toys he or she is holding) would be identified as salient regions for later use (e.g., to be reconstructed for a merged memory as further discussed herein).

In some implementations, the salient region detection instruction set 630 uses machine learning for object identification. In some implementations, the machine learning model is a neural network (e.g., an artificial neural network), decision tree, support vector machine, Bayesian network, or the like. For example, the region detection instruction set 630 uses a region detection neural network instruction set to identify objects and/or an object classification neural network to classify each type of object.

In some implementations, the content assessment instruction set 620 includes a scene understanding instruction set 640 that is configured with instructions executable by a processor to analyze the content information and salient region detection data and determine additional attributes associated with the captured memory. In some implementations, the scene understanding instruction set 640 of the content assessment instruction set 620 analyzes RGB image data associated with the memory content 610 to identify lighting data 642 associated with the captured memory 602. Additionally, in some implementations, the scene understanding instruction set 640 of the content assessment instruction set 620 analyzes RGB images from a light intensity camera with a depth map from a depth camera (e.g., time-of-flight sensor) and other sources of physical environment information (e.g., camera positioning information from a camera's SLAM system, VIO, or the like such as position sensors) to determine an identified location area 645 of the 3D floorplan 644 of the captured memory 602. For example, the scene understanding may identify a 3D area that the two-dimensional (2D) frame(s) of captured memory (e.g., image/video) that coincides or matches with the previously generated 3D room plan 300 of FIGS. 3-5. For example, determining a match between the captured memory and the 3D room plan 300 may be based on identifying and comparing one or more regions or interest such as an object or an area around a particular object (e.g., the couch 120). Thus, when the system determines a potential match, the system may identify a location of the salient regions of the memory content at a corresponding location in the persistent model.

In an example implementation, the environment 600 further includes a 3D representation instruction set 650 that is configured with instructions executable by a processor to obtain the memory content 610 from the content assessment instruction set 620, the salient region data from the salient region detection instruction set 630, and the scene data from the scene understanding instruction set 640, and generate 3D memory representation data 652 (e.g., a dense point cloud reconstruction) using one or more techniques. In other words, the 3D representation instruction set 650 generates a 3D mesh for one or more frames of the detected salient regions from the captured memory 602. For example, for the salient regions detected and included in a salient region identification list, the 3D representation instruction set 650 generates a 3D mesh 651 for identified salient person 631, 3D mesh 651 for identified salient region 632, 3D mesh 653 for identified salient person 633, 3D mesh 654 for identified salient region 634, 3D mesh 655 for identified salient person 635, and 3D mesh 656 for identified salient region 636. Additionally, since salient region 638, 639, were excluded from the salient region identification list, then 3D meshes were not generated for those objects (e.g., the algorithm determines that the children and the respective toys they were holding to be included in the 3D memory representation data 652).

In some implementations, the 3D representation instruction set 650 generates the 3D memory representation data 652 that includes scene data, such as lighting representation 657. For example, the ambient light data associated with the captured memory 602 (e.g., sunlight coming in from the window) may be captured and included with the 3D memory representation data 652 so that viewing the 3D memory representation data 652 of the capture memory 602 would appear to have the sunlight shining on them from the same respective location. Algorithms associated with a viewing device of the 3D memory representation data 652 may be able to remove and/or alter the lighting effects, but the 3D memory representation data 652 may include the original lighting so that a user may feel that they are viewing the capture memory 602 more realistically that includes the lighting effects at the moment the memory was captured (e.g., watching a recorded video). Additionally, or alternatively, in some implementations, not only can the lighting information be used, but also the visual context. For instance, if the couch in a persistent model is green but the current couch is now covered with a white couch cover, then the white color shown in the capture memory 602 may be used to modify the green couch in the persistent model.

The 3D memory representation data 652 could be 3D mesh representation representing the surfaces of the object (e.g., a uniquely shaped toy) in a 3D environment using a 3D point cloud. In some implementations, the 3D memory representation data 652 is a 3D reconstruction mesh that is generated using a meshing algorithm based on depth information detected in the physical environment that is integrated (e.g., fused) to recreate the physical environment. A meshing algorithm (e.g., a dual marching cubes meshing algorithm, a poisson meshing algorithm, a tetrahedral meshing algorithm, or the like) can be used to generate a mesh. In some implementations, for 3D reconstructions using a mesh, to efficiently reduce the amount of memory used in the reconstruction process, a voxel hashing approach is used in which 3D space is divided into voxel blocks, referenced by a hash table using their 3D positions as keys. The voxel blocks are only constructed around object surfaces, thus freeing up memory that would otherwise have been used to store empty space. The voxel hashing approach is also faster than competing approaches at that time, such as octree-based methods. In addition, it supports streaming of data between the GPU, where memory is often limited, and the CPU, where memory is more abundant.

In some implementations, the 3D memory representation data 652 (e.g., 3D model data of the identified salient regions for the captured memory 602) is determined based on refined images, where the refined images are determined based on at least one of 3D keypoint interpolation, densification of 3D sparse point clouds associated with the images, a 2D mask corresponding to the object to remove background image pixels of the images, and/or a 3D bounding box constraint corresponding to the object to remove background image pixels of the images. In some implementations, the 3D keypoint interpolation, the densification of the 3D sparse point clouds, the 2D mask, and the 3D bounding box constraint are based on the coordinate system (e.g., pose tracking data) of an object.

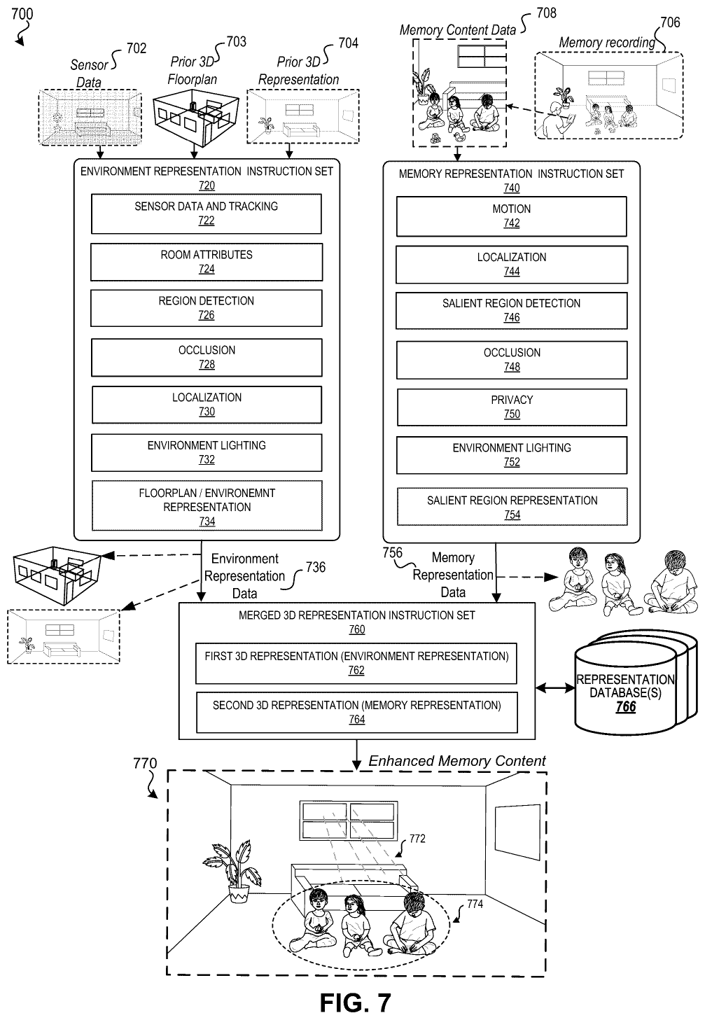

The example environment 600 of FIG. 6 illustrates an exemplary embodiment from a high-level perspective of generating data for reconstruction. The functions and illustrations associated with the content assessment instruction set 620, which includes a salient region detection instruction set 630 and a scene understanding instruction set 640, as illustrated in FIG. 6 is to provide an example process for identifying salient region data (e.g., people and other regions of interest) and scene understanding data (e.g., environment lighting data at the time of capture) in order to reconstruct a 3D representation of the key components of a captured image/video memory. The example process for generating 3D memory representation data 652 as illustrated in FIG. 6, is further described with additional modules/algorithms within the memory representation instruction set 740 as illustrated in FIG. 7.

FIG. 7 illustrates an exemplary environment 700 to generate and display enhanced memory content by merging an environment representation and a memory representation, in accordance with some implementations. In some implementations, process(es) of the environment 700 is performed on a device (e.g., device 105, 110, 305, and the like), such as a mobile device, desktop, laptop, HMD, or server device. In some implementations, process(es) of the environment 700 is performed on processing logic, including hardware, firmware, software, or a combination thereof. In some implementations, process(es) the environment 700 is performed on a processor executing code stored in a non-transitory computer-readable medium (e.g., a memory).

FIG. 7 illustrates exemplary embodiments of various implementations to generate and display enhanced memory content by merging two different 3D representations. For example, a first 3D representation (e.g., an environment representation based on a 3D floorplan as described in FIGS. 2-5) includes a representation of a current physical environment (e.g., a room of a house) that is either obtained from a different device or database, or updated from a current device, and a second 3D representation (e.g., a memory representation as described in FIG. 6) includes a representation of a captured memory (e.g., salient regions, scene data, etc.). FIG. 7 further illustrates additional processes that may be involved in determining, obtaining, and/or updating the different 3D representations.

The environment 700 includes an environment representation instruction set 720 (e.g., a first 3D representation) that obtains, generates, and/or updates environment representation data 736, a memory representation instruction set 740 (e.g., a second 3D representation) that generates memory representation data 756, and a merged 3D representation instruction set 760 that merges/combines the 3D representation data to generate enhanced memory content 770.

The first 3D representation process for obtaining, updating, and/or generating an environment representation, an environment representation instruction set 720 may obtain sensory data 702, prior 3D floorplan 703, and/or prior 3D representation 704, and generate and/or update environment representation data 736. The sensor data 702 includes data from a first physical environment (e.g., device 105 or device 110 obtaining sensor data of physical environment 100). The sensor data 702 may include image data, depth data, positional information, and the like. For example, sensors on a device (e.g., camera's, IMU, etc. on device 105, 110, etc.) can capture information about the position, location, motion, pose, etc., of the head and/or body of a user and the environment. The prior 3D floorplan 703 includes data from a previous floorplan generation system as described in FIGS. 2-5, and the prior 3D representation 704 is a 3D representation of the physical environment that is obtained from another device, a server, and/or a database storing a previously acquired 3D representation. Additionally, or alternatively, in some implementations, the previously acquired 3D representation may be a persistent 3D model of the environment that is built and refined over time, such as a SLAM map, or the like.

The environment representation instruction set 720 may include one or more modules that may then be used to analyze the sensor data 702, prior 3D floorplan 703, or the prior 3D representation 704. The environment representation instruction set 720 may include a sensor data and tracking 722 for determining and tracking the sensor data to determine if update to the obtained prior 3D representation 704 are needed. The environment representation instruction set 720 may include a room attributes model 724 for identifying different room attributes associated with a physical environment such as identifying walls, floors, ceiling, doors, windows, etc. based on one or more known techniques. The environment representation instruction set 720 may include a region detection module 726 can analyze RGB images from a light intensity camera and/or a sparse depth map from a depth camera (e.g., time-of-flight sensor) and other sources of physical environment information (e.g., camera positioning information from a camera's SLAM system, VIO, or the like such as position sensors) to identify objects (e.g., people, pets, etc.) in the sequence of light intensity images. In some implementations, the region detection module 726 uses machine learning for object identification. In some implementations, the machine learning model is a neural network (e.g., an artificial neural network), decision tree, support vector machine, Bayesian network, or the like. For example, the region detection module 726 uses a region detection neural network unit to identify objects and/or an object classification neural network to classify each type of object. The environment representation instruction set 720 may further include an occlusion module 728 for detecting occlusions in the object model. For example, if a viewpoint changes for the viewer, and an occlusion is detected, the system may then determine to hallucinate any gaps of data that may be missing based on the detected occlusions between one or more objects. For example, an initial room scan may not acquire image data of the area behind the couch 120 of FIG. 1, but if the user 102 moves to a position where the viewpoint may show that area that was occluded by the original capture viewpoint, then the occlusion module 728 can indicate which area may need to be hallucinated based on the surrounding (known) data from the original room scan. The environment representation instruction set 720 may include a localization module 730 is configured with instructions executable by a processor to obtain sensor data (e.g., RGB data, depth data, etc.) and track a location of a moving device (e.g., device 105, 110, etc.) in a 3D coordinate system using one or more techniques (e.g., track as a user moves around in a 3D environment to determine a particular viewpoint as discussed herein).

The environment representation instruction set 720 may further include an environment lighting module 732 for determining environment lighting data (e.g., ambient light, incandescent light, etc.) associated with the physical environment. The environment representation instruction set 720 may further include a floorplan module 734 for generating, maintaining, and/or updating a 3D floorplan and 3D representation of the physical environment (e.g., updating a current room 3D representation based on updated sensor data).

The environment representation instruction set 720, utilizing the one or more modules, generates and provides environment representation data 736 to a merged 3D representation instruction set 760 that is configured to generate/obtain/maintain the first 3D representation (environment representation) 762 and combine with the second 3D representation (memory representation) 764 and generate the enhanced memory content 770.

A second 3D representation process for obtaining, updating, and/or generating a 3D memory representation utilizes a memory representation instruction set 740 that may obtain memory content data 708 (e.g., a recorded image/video) based on a memory recording 706 (e.g., a recorded image/video of children in a living room) and generate memory representation data 756 (e.g., representations of salient regions and scene data within the recorded memory).

The memory representation instruction set 740 may include one or more modules that may then be used to analyze the sensor data 702, prior 3D floorplan 703, or the prior 3D representation 704. The memory representation instruction set 740 may include a motion module 742 for determining motion trajectory data from motion sensor(s) for one or more objects. The memory representation instruction set 740 may include a localization module 744 is configured with instructions executable by a processor to obtain sensor data (e.g., RGB data, depth data, etc.) and track a location of a moving device (e.g., device 105, 110, etc.) in a 3D coordinate system using one or more techniques (e.g., track as a user moves around in a 3D environment to determine a particular viewpoint as discussed herein). The memory representation instruction set 740 may include a salient region detection module 746 that can analyze RGB images from a light intensity camera and/or a sparse depth map from a depth camera (e.g., time-of-flight sensor) and other sources of physical environment information (e.g., camera positioning information from a camera's SLAM system, VIO, or the like such as position sensors) to identify objects (e.g., people, pets, etc.) from the memory content data utilizing one or more techniques described herein (e.g., salient region detection instruction set 630). The memory representation instruction set 740 may further include an occlusion module 748 for detecting occlusions in the object model for the salient region detection. For example, if a viewpoint changes for the viewpoint of the recording, and an occlusion is detected between an identified salient region and another object, the system may then determine to hallucinate any gaps of data that may be missing based on the detected occlusions between one or more objects. For example, an initial frame(s) may not acquire image data of the area behind one of the children in FIG. 1, but if the recording moves to a position where the viewpoint may show that area that was occluded by the first frame(s) viewpoint, then the occlusion module 728 can indicate which area may need to be hallucinated based on the surrounding (known) data.

The memory representation instruction set 740 may further include a privacy module 750 that may be based on one or more user settings and/or default system settings that control the amount of blurring or masking particular areas of the background data or particular people to be shown to another user during a viewing of the recorded memory. For example, based on a threshold distance setting, only a particular radial distance around the user or the salient regions may be displayed (e.g., a five-foot radius), and then the remaining portion of the background data would be blurred. Additionally, all of the background data may be blurred for privacy purposes. Additionally, or alternatively, identified objects that show personal identifying information may be modified.

The memory representation instruction set 740 may further include an environment lighting module 752 (e.g., scene understanding instruction set 640 of FIG. 6) for determining the recorded environment lighting data (e.g., ambient light, incandescent light, etc.) associated with the physical environment during the recording. The memory representation instruction set 740 may further include a salient region representation module 754 (e.g., 3D representation instruction set 650 of FIG. 6) for generating, maintaining, and/or updating 3D representation(s) of the one or more identified salient regions and environment characteristics (e.g., lighting) associated with the memory content data 708.

The memory representation instruction set 740, utilizing the one or more modules, generates and provides memory representation data 756 to the merged 3D representation instruction set 760 that is configured to generate/obtain/maintain the first 3D representation (environment representation) 762 and combine with the second 3D representation (memory representation) 764 and generate the enhanced memory content 770. The merged 3D representation instruction set 760, after generating the enhanced memory content 770 may store and access all 3D merged representations for future playback in the one or more representation database(s) 766. In some implementations, the merged 3D representation instruction set 760 may generate (e.g., hallucinate) content when merging the environment representation data 736 and the memory representation data 756 based on the stored 3D representation from the one or more representation database(s) 766, or based on the environment representation data to augment any missing data from the memory representation data 756 (e.g., a previous scan of the environment may have additional information regarding one or more objects that that were not included in the memory recording). The hallucination of new data for the merged 3D representation may also be based on obtaining other representation for one or more other sources, such as other applications that generate 3D representations of objects and/or people.

Additionally, or alternatively, in some implementations, the merging of the 3D representation data and the memory content may be based on one or more different aspects. For instance, the system may need to identify where the first representation should be matched with the second representation. Thus, there may need to be some comparison of image features to identify localization correspondence, and then identifying exactly where the salient regions should be positioned in the first representation. In some implementations, the exact location of the salient regions may be determined by analyzing the memory content data (e.g., perhaps to identify keypoints and depth of those regions) and using matching features of the memory content data and the environment representation to identify where the regions should be positioned in the environment representation.

One or more of the modules included in the environment representation instruction set 720 or the memory representation instruction set 740 may be executed at a recording device, a viewing device, another device (e.g., a server), or a combination thereof. For example, the device 110 may be a recording device (e.g., a mobile device recording a video of children) obtains memory content data 708 of a physical environment 100 and sends the recorded memory to the device 110 (e.g., a viewing device) to be analyzed to generate the merged 3D representation. Additionally (or alternatively), the device 105 may be the recording device that records a scene with a smaller field-of-view (e.g., less memory) but during playback is able to view the entire 3D scene of the physical environment.

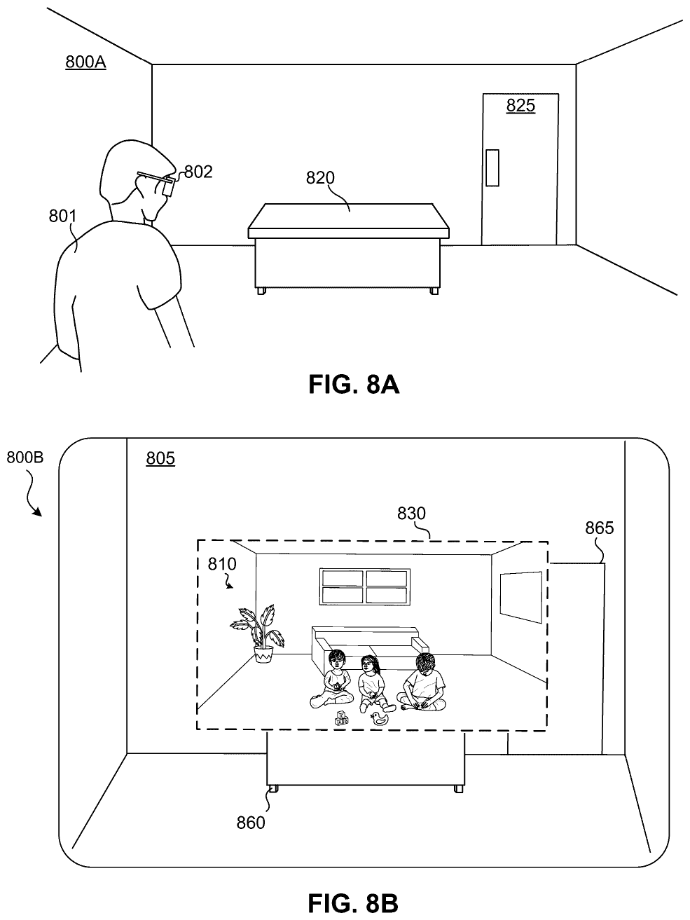

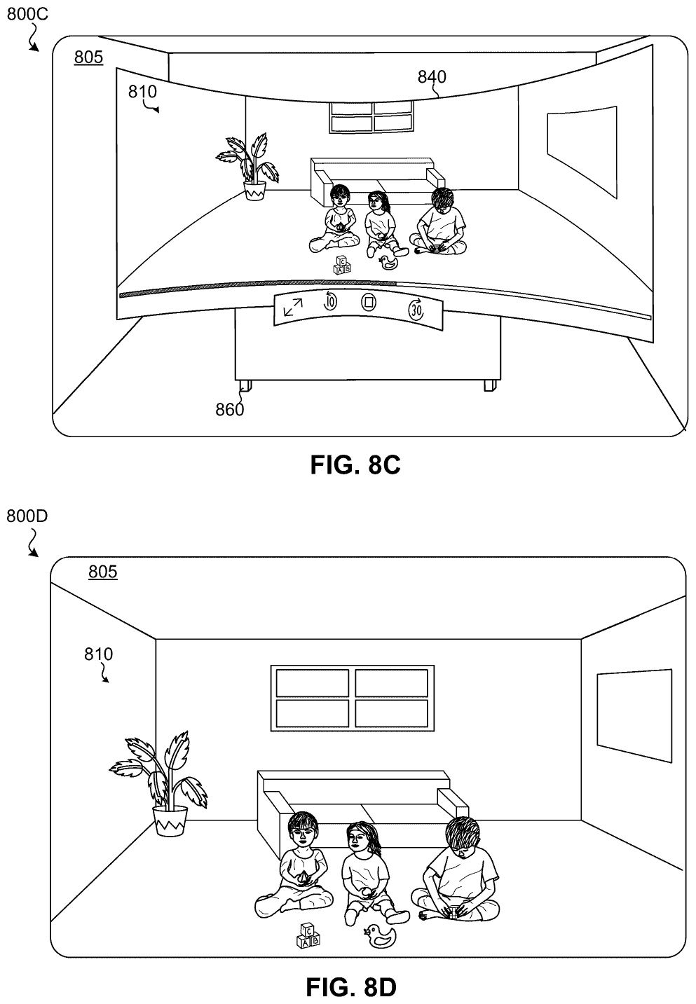

FIG. 8A illustrates exemplary electronic device 802 operating in a physical environment 800A. In particular, FIG. 8A illustrates an exemplary electronic device 802 operating in a different physical environment (e.g., physical environment 800A) than the physical environment of FIGS. 1A-1B (e.g., physical environment 100). In the example of FIG. 8A, the physical environment 800A is a room that includes a desk 820 and a door 825. The electronic device 802 may include one or more cameras, microphones, depth sensors, or other sensors that can be used to capture information about and evaluate the physical environment 800A and the objects within it, as well as information about the user 801 of electronic device 802. The information about the physical environment 800A and/or user 801 may be used to provide visual and audio content and/or to identify the current location of the physical environment 800A and/or the location of the user within the physical environment 800A.

In some implementations, views of an XR environment may be provided to one or more participants (e.g., user 801 and/or other participants not shown, such as user 102) via electronic devices 802, e.g., a wearable device such as an HMD, and/or a handheld device such as a mobile device, a tablet computing device, a laptop computer, etc. (e.g., device 110). Such an XR environment may include views of a 3D environment that is generated based on camera images and/or depth camera images of the physical environment 800A as well as a representation of user 801 based on camera images and/or depth camera images of the user 801. Such an XR environment may include virtual content that is positioned at 3D locations relative to a 3D coordinate system (e.g., a 3D space) associated with the XR environment, which may correspond to a 3D coordinate system of the physical environment 100.

In some implementations, video (e.g., pass-through video depicting a physical environment) is received from an image sensor of a device (e.g., device 802) and used to present the XR environment. In other implementations, optical see-through may be used to present the XR environment by overlaying virtual content on a view of the physical environment seen through a translucent or transparent display. In some implementations, a 3D representation of a virtual environment is aligned with a 3D coordinate system of the physical environment. A sizing of the 3D representation of the virtual environment may be generated based on, inter alia, a scale of the physical environment or a positioning of an open space, floor, wall, etc. such that the 3D representation is configured to align with corresponding features of the physical environment. In some implementations, a viewpoint within the 3D coordinate system may be determined based on a position of the electronic device within the physical environment. The viewpoint may be determined based on, inter alia, image data, depth sensor data, motion sensor data, etc., which may be retrieved via a virtual inertial odometry system (VIO), a simultaneous localization and mapping (SLAM) system, etc.

FIGS. 8B-8D illustrate exemplary views 800B-800D, respectively, of an extended reality (XR) environment provided by an electronic device 802 (e.g., an HMD, such as device 105 of FIG. 1B) in accordance with some implementations. The views 800B, 800C, 800D may be a live camera view of the physical environment 800A, a view of the physical environment 800A through a see-through display, or a view generated based on a 3D model corresponding to the physical environment 800A. The views 800B, 800C, 800D may include depictions of aspects of the physical environment 800A such as a representation 860 of desk 820, representation 865 of door 825, and the like, within a view of the 3D environment 805.

In particular, view 800B of FIG. 8BA illustrates providing content 810 (e.g., enhanced memory content 770 of FIG. 7) for display on a virtual screen 830 (e.g., viewing the enhanced recorded memory on a portal). The content 810 refers to the combined 3D representation described herein (e.g., an enhanced memory of the image content recorded in FIGS. 1A-1B). View 800C of FIG. 8C illustrates providing content 810 for display within the 3D environment 805 (e.g., a more immersive view than view 800B, as the user is looking at a virtual panoramic viewing portal 840 of the content 810). View 800D of FIG. 8D illustrates providing content 810 for display within the 3D environment 805. For example, view 800D illustrates a completely immersive view of the memory, such that a viewer (e.g., user 801) views a 3D representation of the entire environment 100 of FIG. 1A-1B with the enhanced memory (e.g., the user 801 may turn his or her head and view other aspects/viewpoints of the representation of the physical environment 100).

Additionally, or alternatively, in some implementations, an exemplary view of the content 810 (e.g., an enhanced memory) may include environment lighting conditions associated with the recorded memory, as opposed to the environment lighting conditions associated with the persistent model of the physical environment, which may have filtered out lighting conditions. For example, a user may see lighting conditions of the physical environment 100 in view 800B, 800C, and 800D from the original recorded memory (e.g., sunlight coming in the window), in order to view an enhanced memory.

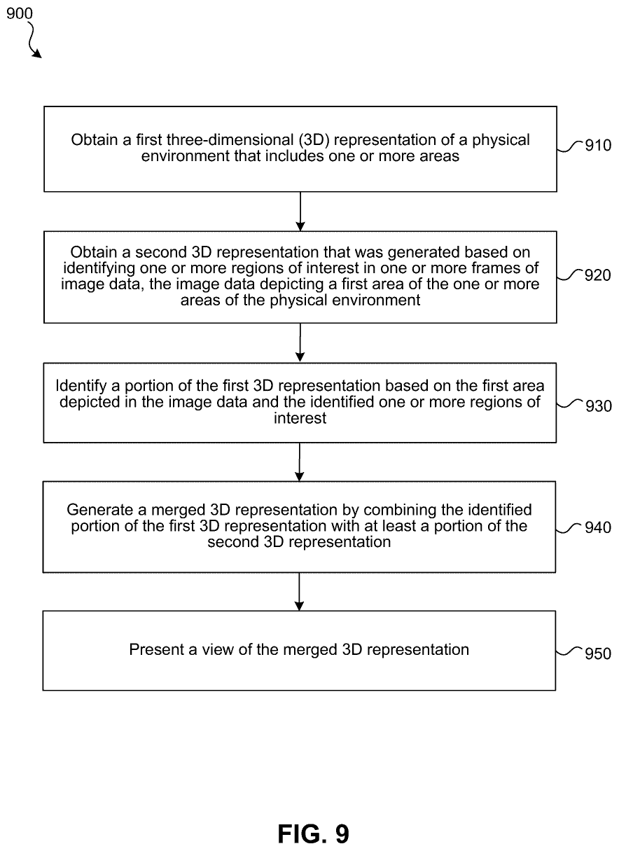

FIG. 9 is a flowchart illustrating a method 900 for presenting a view of a merged 3D representation in accordance with some implementations. In some implementations, a device such as electronic device 110 performs method 900. In some implementations, method 900 is performed on a mobile device, desktop, laptop, HMD (e.g., device 110), or server device. The method 900 is performed by processing logic, including hardware, firmware, software, or a combination thereof. In some implementations, the method 900 is performed on a processor executing code stored in a non-transitory computer-readable medium (e.g., a memory). In some implementations, the device performing the method 900 includes a processor and one or more sensors.

In various implementations, method 900 displays an immersive memory by identifying subjects of interest of a recorded image or video and merging the identified subjects of interest form the recording with an obtained persistent model (e.g., an immersive view, such as a larger field-of-view for a 3D environment). For example, a view of the immersive memory (e.g., a 3D environment) may be displayed on a first device (e.g., a head mounted device (HMD)) based on merging a previously generated 3D representation of a physical environment (e.g., a 3D persistent ‘reusable’ model of a home) with a 3D representation of a captured video (e.g., a memory) for a particular area (e.g., a living room) captured by a second device (e.g., a mobile phone or tablet with a smaller FOV of the captured image/video).

At block 910, the method obtains a first 3D representation of a physical environment that includes one or more areas. The first 3D representation may include the first 3D representation (environment representation) 762 generated by the environment representation instruction set 720. For example, obtaining a 3D persistent model of a scene (home), such as the 3D room plan 300 of FIGS. 3-5 that was generated based on a 3D point cloud (e.g., point cloud 200 of FIG. 2). The 3D model of the home, room, etc., may be stored on the first device (e.g., the viewing device, such as an HMD, device 105), from another device (e.g., a mobile device, such as device 110), a server, a database, and the like. In some implementations, the 3D model of a scene may be tracked/developed and changed over time (e.g., as a user scan's his or environment, the 3D model may be constantly updated to be kept up to date).

At block 920, the method 900 obtains a second 3D representation that was generated based on identifying one or more regions of interest in one or more frames of image data, the image data depicting a first area of the one or more areas of the physical environment. The second 3D representation (e.g., a 3D photo of one or more regions of interest in the scene) refers to the second 3D representation (memory representation) 764 generated by the memory representation instruction set 740. The second 3D representation may also be referred to as the 3D memory representation data 652 generated by the 3D representation instruction set 650 of FIG. 6 (e.g., the memory representation of the identified salient regions, such as the children and the toys they were holding or playing with).

At block 930, the method 900 identifies a portion of the first 3D representation based on the first area depicted in the image data and the identified one or more regions of interest. For example, the process identifies the portions from the persistent model (e.g., a 3D representation of one or more areas/rooms of a building, home, or other physical environment) corresponding to portions of the area/room depicted in the image data and surroundings that are out of view. In other words, identifying where in the house the image/video memory was recorded with a smaller field-of-view in order to provide a larger field-of-view of the memory.

At block 940, the method 900 generates a merged 3D representation by combining the identified portion of the first 3D representation with at least a portion of the second 3D representation. The merged 3D representation (e.g., a 3D reconstructed photo of one or more regions of interest from a record memory for limited viewing area combined with a 3D reconstructed model of the entire area) refers to the enhanced memory content 770 of FIG. 7 generated by the merged representation instruction set 760. For example, the merged 3D representation is generated by obtaining an environment representation and using only the identified subjects of interest (e.g., salient people/objects) of the 3D image memory recording or using the people and other surroundings of the 3D image.

At block 950, the method 900 presents a view of the merged 3D representation. In other words, the identified and reconstructed salient regions from the limited field-of-view of the captured memory may be displayed by a device that includes a larger field-of-view than the captured image data. For example, a user, using a mobile device (e.g., a mobile phone), captures a video of the three children playing with toys (e.g., at a birthday party). Then the user wants to replay the recorded memory using a device with a larger field-of-view, such as an HMD. The merged 3D representation then allows the user to view the recorded memory with a larger view of the surrounding area, and even allow a user to be fully immersed in the memory and be able to look around the room while the recorded memory is being viewed (e.g., look and/or move around the reconstructed living room while the kids are playing).

In some implementations, the second 3D representation was further generated by identifying one or more scene properties based on the one or more frames of image data. The scene properties may include occlusions, lighting data, motion data (of the capture device or of the one or more objects in the scene), location data, privacy data associated with the scene, etc. In some implementations, identifying the one or more scene properties comprises identifying one or more lighting properties associated with a lighting condition of the first area of the physical environment. In some implementations, identifying the one or more scene properties comprises identifying occlusions corresponding to the one or more regions of interest. For example, the occlusion module 748 may determine if there are occlusions between one or more objects in the image data, environment lighting module 752 may determine one or more lighting/illumination characteristics associated with the recorded scene (e.g., light intensity, ambient light data, diffused light from one or more light sources, etc.).

In some implementations, the method 900 further includes updating the merged 3D representation based on the identified one or more scene properties. In some implementations, updating the merged 3D representation based on the identified one or more scene properties comprises hallucinating content for the view of the merged 3D representation. For example, the system may transfer scene properties such as lighting, and complete the background of the merged 3D representation with the matched lighting and rendering the lighting effects upon the regions of interest as well as render the lighting conditions upon the entire scene associated with the merged 3D representation. In other words, the merged 3D representation may appear to the viewer that sunlight is coming from the window and creates effects on all objects from the first representation (e.g., shadows created by the couch which was not included in the regions of interest data).

In some implementations, identifying the one or more regions of interest based on the one or more frames of image data includes extracting data (e.g., RGB, depth, etc.) from the image data corresponding to one or more persons. In some implementations, identifying the one or more regions of interest based on the one or more frames of image data includes extracting data from the image data corresponding to one or more persons and extracting data from the image data corresponding to objects associated with the one or more persons (e.g., extracting a toy the child is playing with). For example, the regions of interest (e.g., salient regions) are identified based on extracting foreground objects/people and/or objects associated with people (e.g., children holding toys). In some implementations, the second 3D representation includes a plurality of persons, wherein identifying the one or more regions of interest based on the one or more frames of image data includes extracting data from the image data corresponding to at least one person of the plurality of persons based on prioritization parameters. For example, the second 3D representation is generated based on extracting foreground objects/people, and may be based on prioritizing objects/people based on one or more parameters. For example, a prioritization parameter may be based on a list of known people from a stored social list (e.g., family), such that people may be identified based on region detection and facial recognition processes in order to identify a person and whether or not that person is a subject of interest that should be included (or excluded). The approved list may be automatically correlated with another application, such as a social media application, or may be separately maintained by the user (e.g., via photo applications). For example, if the recorded memory includes several people at a party, only particular people may be included as the regions of interest, and thus recreated in the merged 3D representation.

In some implementations, identifying the one or more regions of interest based on the one or more frames of image data includes determining that the second 3D representation is missing at least a portion of an identified first region of interest. In some implementations, generating the merged 3D representation includes excluding data from the second 3D representation corresponding to the identified first region of interest. For example, if the recorded memory shows a person cut off on a few or several frames of the images, and the person may be listed as a prioritized person, the system may then determine whether or not to hallucinate the missing data or exclude the person from the memory representation.

In some implementations, generating the merged 3D representation includes generating (e.g., hallucinating) additional content associated with the at least the portion of the identified first region of interest. For example, if the system determines to hallucinate the content (e.g., generate new content to fill in gaps and missing content), this may be based on obtaining additional content data for the identified object (e.g., a content database or representation database that includes images and/or 3D representations of the person that is cutoff from frames of the recorded memory).

In some implementations, identifying the portion of the first 3D representation based on the first area depicted in the image data and the identified one or more regions of interest is based on location data, object recognition data, or a combination thereof. For example, in order to match the first 3D representation (e.g., a persistent updated model of the home) and the second 3D representation (e.g., captured memory representation).

In some implementations, the view of the merged 3D representation is displayed on a larger field-of-view (e.g., 180° field-of-view or larger) than a field-of-view associated with the image data (e.g., the field-of-view of the image/video captured on the capture device, such as a mobile phone). In other words, the enhanced view of the merged 3D representation (e.g., enhanced memory content 770) is an expanded view of the original captured memory image/video.

In some implementations, the first 3D representation includes a temporal-based attribute that corresponds to a version of the first 3D representation. For example, a timestamp may be attributed to the persistent model of the home (e.g., environment representation), such if the timestamp indicates the currently stored 3D model of the home is older than particular length of time (e.g., older than a day, week, month, etc.). In some implementations, the method 900 further includes determining, based on the temporal-based attribute, that there is an updated version of the first 3D representation, obtaining the updated version of the first 3D representation, and updating the merged 3D representation based on the updated version of the first 3D representation. For example, if the persistent model of the home environment representation is outdated (e.g., a locally stored version of the 3D model of the home), then the system may communicate with a server or database to obtain an updated version (if available). Additionally, or alternatively, the system may update the 3D environment representation by acquiring live sensor data (RGB, depth, etc.) and update the current 3D environment representation.

In some implementations, the first 3D representation was generated by the first electronic device. For example, the viewing device, such as device 105, an HMD, may have generated a 3D representation of the physical environment (e.g., a room, house, floorplan etc.), and then generate the merged 3D representation after obtaining 3D representation of the captured memory (e.g., the 3D representation of the identified salient regions). In some implementations, the first 3D representation or the second 3D representation was obtained from a second electronic device. For example, both the 3D representation of the physical environment and the 3D representation of the captured memory is obtained from another device (e.g., another HMD, mobile device, a server, etc.), before generating the merged 3D representation for viewing. In some implementations, the merged 3D representation is presented in an extended reality (XR) environment (e.g., views 800B, 800C, and 800D illustrated in FIGS. 8B-8D respectively).

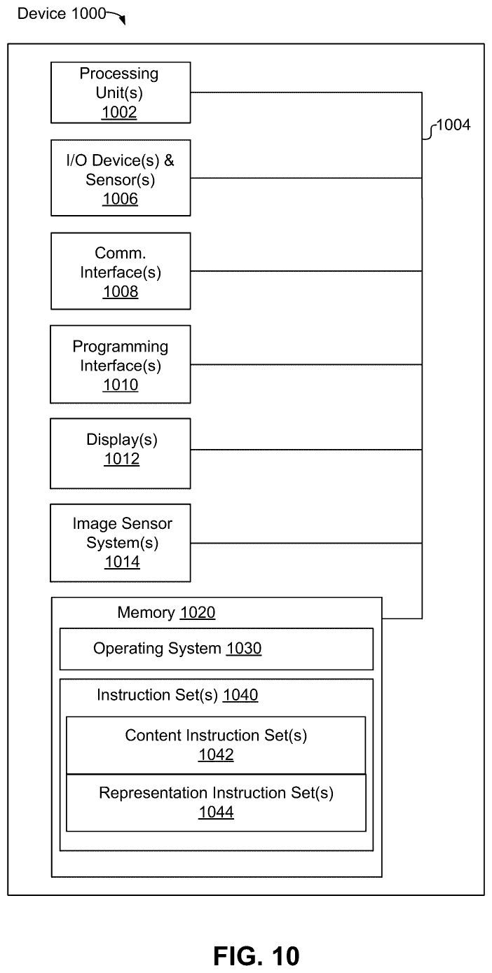

FIG. 10 is a block diagram of electronic device 1000. Device 1000 illustrates an exemplary device configuration for electronic device 110, 105, or the like. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the device 1000 includes one or more processing units 1002 (e.g., microprocessors, ASICs, FPGAs, GPUs, CPUs, processing cores, and/or the like), one or more input/output (I/O) devices and sensors 1006, one or more communication interfaces 1008 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, SPI, 12C, and/or the like type interface), one or more programming (e.g., I/O) interfaces 1010, one or more output device(s) 1012, one or more interior and/or exterior facing image sensor systems 1014, a memory 1020, and one or more communication buses 1004 for interconnecting these and various other components.

In some implementations, the one or more communication buses 1004 include circuitry that interconnects and controls communications between system components. In some implementations, the one or more I/O devices and sensors 1006 include at least one of an inertial measurement unit (IMU), an accelerometer, a magnetometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some implementations, the one or more output device(s) 1012 include one or more displays configured to present a view of a 3D environment to the user. In some implementations, the one or more device(s) 1012 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electromechanical system (MEMS), and/or the like display types. In some implementations, the one or more displays correspond to diffractive, reflective, polarized, holographic, etc. waveguide displays. In one example, the device 1000 includes a single display. In another example, the device 1000 includes a display for each eye of the user.

In some implementations, the one or more output device(s) 1012 include one or more audio producing devices. In some implementations, the one or more output device(s) 1012 include one or more speakers, surround sound speakers, speaker-arrays, or headphones that are used to produce spatialized sound, e.g., 3D audio effects. Such devices may virtually place sound sources in a 3D environment, including behind, above, or below one or more listeners. Generating spatialized sound may involve transforming sound waves (e.g., using head-related transfer function (HRTF), reverberation, or cancellation techniques) to mimic natural soundwaves (including reflections from walls and floors), which emanate from one or more points in a 3D environment. Spatialized sound may trick the listener's brain into interpreting sounds as if the sounds occurred at the point(s) in the 3D environment (e.g., from one or more particular sound sources) even though the actual sounds may be produced by speakers in other locations. The one or more output device(s) 1012 may additionally or alternatively be configured to generate haptics.

In some implementations, the one or more image sensor systems 1014 are configured to obtain image data that corresponds to at least a portion of a physical environment. For example, the one or more image sensor systems 1014 may include one or more RGB cameras (e.g., with a complimentary metal-oxide-semiconductor (CMOS) image sensor or a charge-coupled device (CCD) image sensor), monochrome cameras, IR cameras, depth cameras, event-based cameras, and/or the like. In various implementations, the one or more image sensor systems 1014 further include illumination sources that emit light, such as a flash. In various implementations, the one or more image sensor systems 1014 further include an on-camera image signal processor (ISP) configured to execute a plurality of processing operations on the image data.

The memory 1020 includes high-speed random-access memory, such as DRAM, SRAM, DDR RAM, or other random-access solid-state memory devices. In some implementations, the memory 1020 includes non-volatile memory, such as one or more magnetic disk storage devices, optical disk storage devices, flash memory devices, or other non-volatile solid-state storage devices. The memory 1020 optionally includes one or more storage devices remotely located from the one or more processing units 1002. The memory 1020 includes a non-transitory computer readable storage medium.

In some implementations, the memory 1020 or the non-transitory computer readable storage medium of the memory 1020 stores an optional operating system 1030 and one or more instruction set(s) 1040. The operating system 1030 includes procedures for handling various basic system services and for performing hardware dependent tasks. In some implementations, the instruction set(s) 1040 include executable software defined by binary information stored in the form of an electrical charge. In some implementations, the instruction set(s) 1040 are software that is executable by the one or more processing units 1002 to carry out one or more of the techniques described herein.

The instruction set(s) 1040 includes a content instruction set 1042, and a representation instruction set 1044. The instruction set(s) 1040 may be embodied a single software executable or multiple software executables.

In some implementations, the content instruction set 1042 is executable by the processing unit(s) 1002 to provide and/or track content for display on a device. The content instruction set 1042 may be configured to monitor and track the content over time (e.g., during an experience). To these ends, in various implementations, the instruction includes instructions and/or logic therefor, and heuristics and metadata therefor.

In some implementations, the representation instruction set 1044 is executable by the processing unit(s) 1002 to generate representation data using one or more 3D rendering techniques discussed herein or as otherwise may be appropriate. To these ends, in various implementations, the instruction includes instructions and/or logic therefor, and heuristics and metadata therefor.

Although the instruction set(s) 1040 are shown as residing on a single device, it should be understood that in other implementations, any combination of the elements may be located in separate computing devices. Moreover, the figure is intended more as functional description of the various features which are present in a particular implementation as opposed to a structural schematic of the implementations described herein. As recognized by those of ordinary skill in the art, items shown separately could be combined and some items could be separated. The actual number of instructions sets and how features are allocated among them may vary from one implementation to another and may depend in part on the particular combination of hardware, software, and/or firmware chosen for a particular implementation.

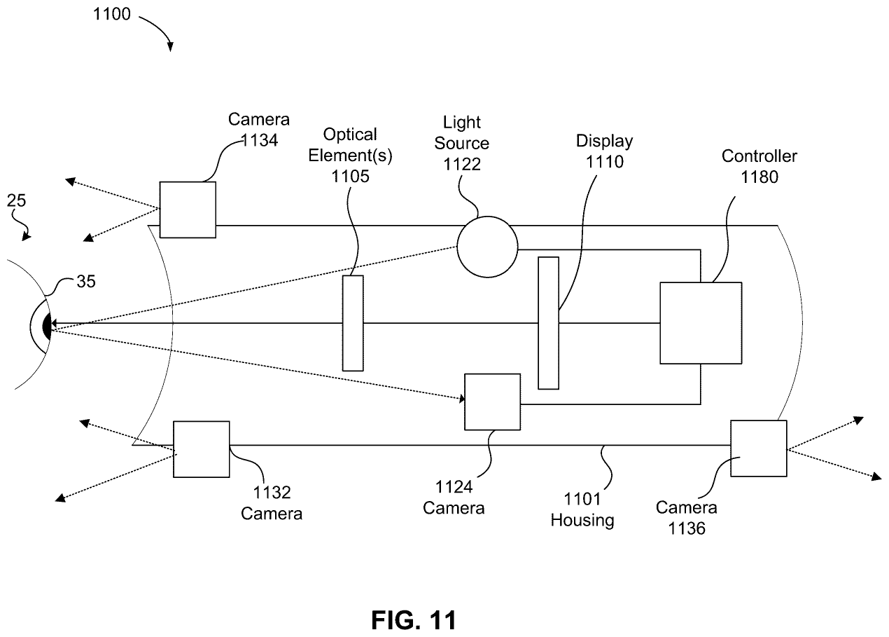

FIG. 11 illustrates a block diagram of an exemplary head-mounted device 1100 in accordance with some implementations. The head-mounted device 1100 includes a housing 1101 (or enclosure) that houses various components of the head-mounted device 1100. The housing 1101 includes (or is coupled to) an eye pad (not shown) disposed at a proximal (to the user 102) end of the housing 1101. In various implementations, the eye pad is a plastic or rubber piece that comfortably and snugly keeps the head-mounted device 1100 in the proper position on the face of the user 102 (e.g., surrounding the eye of the user 102).

The housing 1101 houses a display 1110 that displays an image, emitting light towards or onto the eye of a user 102. In various implementations, the display 1110 emits the light through an eyepiece having one or more optical elements 1105 that refracts the light emitted by the display 1110, making the display appear to the user 102 to be at a virtual distance farther than the actual distance from the eye to the display 1110. For example, optical element(s) 1105 may include one or more lenses, a waveguide, other diffraction optical elements (DOE), and the like. For the user 102 to be able to focus on the display 1110, in various implementations, the virtual distance is at least greater than a minimum focal distance of the eye (e.g., 7 cm). Further, in order to provide a better user experience, in various implementations, the virtual distance is greater than 1 meter.

The housing 1101 also houses a tracking system including one or more light sources 1122, camera 1124, camera 1132, camera 1134, camera 1136, and a controller 1180. The one or more light sources 1122 emit light onto the eye of the user 102 that reflects as a light pattern (e.g., a circle of glints) that may be detected by the camera 1124. Based on the light pattern, the controller 1180 may determine an eye tracking characteristic of the user 102. For example, the controller 1180 may determine a gaze direction and/or a blinking state (eyes open or eyes closed) of the user 102. As another example, the controller 1180 may determine a pupil center, a pupil size, or a point of regard. Thus, in various implementations, the light is emitted by the one or more light sources 1122, reflects off the eye of the user 102, and is detected by the camera 1124. In various implementations, the light from the eye of the user 102 is reflected off a hot mirror or passed through an eyepiece before reaching the camera 1124.

The display 1110 emits light in a first wavelength range and the one or more light sources 1122 emit light in a second wavelength range. Similarly, the camera 1124 detects light in the second wavelength range. In various implementations, the first wavelength range is a visible wavelength range (e.g., a wavelength range within the visible spectrum of approximately 400-700 nm) and the second wavelength range is a near-infrared wavelength range (e.g., a wavelength range within the near-infrared spectrum of approximately 700-1400 nm).

In various implementations, eye tracking (or, in particular, a determined gaze direction) is used to enable user interaction (e.g., the user 102 selects an option on the display 1110 by looking at it), provide foveated rendering (e.g., present a higher resolution in an area of the display 1110 the user 102 is looking at and a lower resolution elsewhere on the display 1110), or correct distortions (e.g., for images to be provided on the display 1110).

In various implementations, the one or more light sources 1122 emit light towards the eye of the user 102 which reflects in the form of a plurality of glints.

In various implementations, the camera 1124 is a frame/shutter-based camera that, at a particular point in time or multiple points in time at a frame rate, generates an image of the eye of the user 102. Each image includes a matrix of pixel values corresponding to pixels of the image which correspond to locations of a matrix of light sensors of the camera. In implementations, each image is used to measure or track pupil dilation by measuring a change of the pixel intensities associated with one or both of a user's pupils.

In various implementations, the camera 1124 is an event camera including a plurality of light sensors (e.g., a matrix of light sensors) at a plurality of respective locations that, in response to a particular light sensor detecting a change in intensity of light, generates an event message indicating a particular location of the particular light sensor.

In various implementations, the camera 1132, camera 1134, and camera 1136 are frame/shutter-based cameras that, at a particular point in time or multiple points in time at a frame rate, may generate an image of the face of the user 102 or capture an external physical environment. For example, camera 1132 captures images of the user's face below the eyes, camera 1134 captures images of the user's face above the eyes, and camera 1136 captures the external environment of the user (e.g., environment 100 of FIG. 1). The images captured by camera 1132, camera 1134, and camera 1136 may include light intensity images (e.g., RGB) and/or depth image data (e.g., Time-of-Flight, infrared, etc.).

It will be appreciated that the implementations described above are cited by way of example, and that the present invention is not limited to what has been particularly shown and described hereinabove. Rather, the scope includes both combinations and sub combinations of the various features described hereinabove, as well as variations and modifications thereof which would occur to persons skilled in the art upon reading the foregoing description and which are not disclosed in the prior art.

As described above, one aspect of the present technology is the gathering and use of sensor data that may include user data to improve a user's experience of an electronic device. The present disclosure contemplates that in some instances, this gathered data may include personal information data that uniquely identifies a specific person or can be used to identify interests, traits, or tendencies of a specific person. Such personal information data can include movement data, physiological data, demographic data, location-based data, telephone numbers, email addresses, home addresses, device characteristics of personal devices, or any other personal information.

The present disclosure recognizes that the use of such personal information data, in the present technology, can be used to the benefit of users. For example, the personal information data can be used to improve the content viewing experience. Accordingly, use of such personal information data may enable calculated control of the electronic device. Further, other uses for personal information data that benefit the user are also contemplated by the present disclosure.

The present disclosure further contemplates that the entities responsible for the collection, analysis, disclosure, transfer, storage, or other use of such personal information and/or physiological data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

Despite the foregoing, the present disclosure also contemplates implementations in which users selectively block the use of, or access to, personal information data. That is, the present disclosure contemplates that hardware or software elements can be provided to prevent or block access to such personal information data. For example, in the case of user-tailored content delivery services, the present technology can be configured to allow users to select to “opt in” or “opt out” of participation in the collection of personal information data during registration for services. In another example, users can select not to provide personal information data for targeted content delivery services. In yet another example, users can select to not provide personal information, but permit the transfer of anonymous information for the purpose of improving the functioning of the device.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences or settings based on non-personal information data or a bare minimum amount of personal information, such as the content being requested by the device associated with a user, other non-personal information available to the content delivery services, or publicly available information.

In some embodiments, data is stored using a public/private key system that only allows the owner of the data to decrypt the stored data. In some other implementations, the data may be stored anonymously (e.g., without identifying and/or personal information about the user, such as a legal name, username, time and location data, or the like). In this way, other users, hackers, or third parties cannot determine the identity of the user associated with the stored data. In some implementations, a user may access their stored data from a user device that is different than the one used to upload the stored data. In these instances, the user may be required to provide login credentials to access their stored data.

Numerous specific details are set forth herein to provide a thorough understanding of the claimed subject matter. However, those skilled in the art will understand that the claimed subject matter may be practiced without these specific details. In other instances, methods apparatuses, or systems that would be known by one of ordinary skill have not been described in detail so as not to obscure claimed subject matter.

Unless specifically stated otherwise, it is appreciated that throughout this specification discussions utilizing the terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general-purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device.

Implementations of the methods disclosed herein may be performed in the operation of such computing devices. The order of the blocks presented in the examples above can be varied for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or value beyond those recited. Headings, lists, and numbering included herein are for ease of explanation only and are not meant to be limiting.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

The foregoing description and summary of the invention are to be understood as being in every respect illustrative and exemplary, but not restrictive, and the scope of the invention disclosed herein is not to be determined only from the detailed description of illustrative implementations but according to the full breadth permitted by patent laws. It is to be understood that the implementations shown and described herein are only illustrative of the principles of the present invention and that various modification may be implemented by those skilled in the art without departing from the scope and spirit of the invention.

What is claimed is:

1. A method comprising:
at a first electronic device having a processor:
obtaining a first three-dimensional (3D) representation of a physical environment, wherein the physical environment comprises one or more areas;
obtaining a second 3D representation that was generated by identifying one or more objects of interest based on one or more frames of image data, wherein the image data depicts a first area of the one or more areas of the physical environment;
identifying a portion of the first 3D representation based on the first area depicted in the image data and the identified one or more regions of interest;
generating a merged 3D representation by combining the identified portion of the first 3D representation with at least a portion of the second 3D representation; and
presenting a view of the merged 3D representation.

2. The method of claim 1, wherein the second 3D representation was further generated by identifying one or more scene properties based on the one or more frames of image data.

3. The method of claim 2, wherein identifying the one or more scene properties comprises identifying one or more lighting properties associated with a lighting condition of the first area of the physical environment.

4. The method of claim 2, wherein identifying the one or more scene properties comprises identifying occlusions corresponding to the one or more regions of interest.

5. The method of claim 2, further comprising: updating the merged 3D representation based on the identified one or more scene properties.

6. The method of claim 5, wherein updating the merged 3D representation based on the identified one or more scene properties comprises hallucinating content for the view of the merged 3D representation.

7. The method of claim 1, wherein identifying the one or more regions of interest based on the one or more frames of image data comprises extracting data from the image data corresponding to one or more persons.

8. The method of claim 1, wherein identifying the one or more regions of interest based on the one or more frames of image data comprises extracting data from the image data corresponding to one or more persons and extracting data from the image data corresponding to objects associated with the one or more persons.

9. The method of claim 1, wherein the second 3D representation comprises a plurality of persons, wherein identifying the one or more regions of interest based on the one or more frames of image data comprises extracting data from the image data corresponding to at least one person of the plurality of persons based on prioritization parameters.

10. The method of claim 1, wherein identifying the one or more regions of interest based on the one or more frames of image data comprises determining that the second 3D representation is missing at least a portion of an identified first region of interest.

11. The method of claim 10, wherein generating the merged 3D representation comprises generating additional content associated with the at least the portion of the identified first region of interest.

12. The method of claim 10, wherein generating the merged 3D representation comprises excluding data from the second 3D representation corresponding to the identified first region of interest.

13. The method of claim 1, wherein identifying the portion of the first 3D representation based on the first area depicted in the image data and the identified one or more regions of interest is based on location data, object recognition data, or a combination thereof.

14. The method of claim 1, wherein the view of the merged 3D representation is displayed on a larger field-of-view than a field-of-view associated with the image data.

15. The method of claim 1, wherein the first 3D representation comprises a temporal-based attribute that corresponds to a version of the first 3D representation.

16. The method of claim 15, further comprising:
determining, based on the temporal-based attribute, that there is an updated version of the first 3D representation;
obtaining the updated version of the first 3D representation; and
updating the merged 3D representation based on the updated version of the first 3D representation.

17. The method of claim 1, wherein the first 3D representation was generated by the first electronic device.

18. The method of claim 1, wherein the first 3D representation or the second 3D representation was obtained from a second electronic device.

19. The method of claim 1, wherein the view of the merged 3D representation is presented in an extended reality (XR) environment.

20. The method of claim 1, wherein the first electronic device comprises a head-mounted device (HMD).

21. A first device comprising:
a non-transitory computer-readable storage medium; and
one or more processors coupled to the non-transitory computer-readable storage medium, wherein the non-transitory computer-readable storage medium comprises program instructions that, when executed on the one or more processors, cause the one or more processors to perform operations comprising:
obtaining a first three-dimensional (3D) representation of a physical environment, wherein the physical environment comprises one or more areas;
obtaining a second 3D representation that was generated by identifying one or more objects of interest based on one or more frames of image data, wherein the image data depicts a first area of the one or more areas of the physical environment;
identifying a portion of the first 3D representation based on the first area depicted in the image data and the identified one or more regions of interest;
generating a merged 3D representation by combining the identified portion of the first 3D representation with at least a portion of the second 3D representation; and
presenting a view of the merged 3D representation.

22. A non-transitory computer-readable storage medium, storing program instructions executable on a first device to perform operations comprising:
obtaining a first three-dimensional (3D) representation of a physical environment, wherein the physical environment comprises one or more areas;
obtaining a second 3D representation that was generated by identifying one or more objects of interest based on one or more frames of image data, wherein the image data depicts a first area of the one or more areas of the physical environment;
identifying a portion of the first 3D representation based on the first area depicted in the image data and the identified one or more regions of interest;
generating a merged 3D representation by combining the identified portion of the first 3D representation with at least a portion of the second 3D representation; and
presenting a view of the merged 3D representation.
